(19) United States
(12) Patent Application Publication
(10) Pub. No.: US 2012/0207917 A1
(43) Pub. Date: Aug. 16, 2012

(54) CONDUCTIVE PATTERN-FORMING COMPOSITION AND METHOD

(75) Inventors: Yoshitaka Hamada, Joetsu-shi (JP); Fujio Yagihashi, Joetsu-shi (JP)

(73) Assignee: SHIN-ETSU CHEMICAL CO., LTD., Tokyo (JP)

(21) Appl. No.: 13/372,673

(22) Filed: Feb. 14, 2012

(30) Foreign Application Priority Data
Feb. 16, 2011 (JP) 2011-031004

(51) Int. Cl. B05D 5/12; H01B 1/22; H01B 1/20

(52) U.S. Cl. 427/98.4; 252/500; 252/512

(57) ABSTRACT

A conductive pattern-forming composition is obtained by loading a silicone rubber composition comprising a curable organopolysiloxane and a curing agent with conductive submicron particles.

### CROSS-REFERENCE TO RELATED APPLICATION

This non-provisional application claims priority under 35 U.S.C. §119(a) on Patent Application No. 2011-031004 filed in Japan on Feb. 16, 2011, the entire contents of which are hereby incorporated by reference.

### TECHNICAL FIELD

This invention relates to a material for forming a microscopic conductive circuit, and more particularly, to a conductive pattern-forming composition for forming a microscopic conductive circuit between substrates when semiconductor devices are stacked, and a method for forming a conductive pattern.

### BACKGROUND ART

As the design rule of semiconductor devices is close to the limit, one miniaturization approach is by stacking two or more chips. When semiconductor chips are stacked to form a circuit, it is important how to form interconnections. For example, JP-A 2010-080897 proposes a method for providing interconnections between chips by forming circuits by the through-silicon via (TSV) technique, providing the circuits with metal plugs, and stacking the circuits while forming contacts to the metal plugs via solder balls. This method, however, needs contact between high hardness metals. Unless solder balls and metal plugs are protruded from the substrate so that all the contact positions may be uniform in height, a problem of fissure or deformation can occur on those contacts where strain is concentrated.

Also a number of circuit forming methods using metal fine powder have been proposed. The circuits formed by these methods ensure conduction with high stability since they are based on the arrangement of metal particles in a circuit pattern as above, but are made of stress sensitive materials as in the above-discussed method.

On the other hand, rubber base materials are resistant to strain. The method of forming contacts through a silicone rubber preform having patterned conductive regions has already been implemented to form contacts between substrates (see JP-A 2001-172506).

The method of JP-A 2001-172506 relies on the rubber elasticity of silicone rubber. When silicone rubber is compressed between substrates, conductive fillers in the conductive pattern come in mutual contact to form a conductive circuit. The rubber elasticity of silicone rubber leads to the advantage that even when heights of wirings on the substrates are more or less different, the wirings are little damaged because the strain is absorbed by the silicone rubber.

### CITATION LIST

Patent Document 1: JP-A 2010-080897 (US 20100244251)
Patent Document 2: JP-A 2001-172506
Patent Document 3: JP-A 2001-023435
Patent Document 4: JP-A H06-157764
Non-Patent Document 1: West R., David L. D., Djurovich P. I., Stearley K. L., Srinivasan K. S., Yu H., J. Amer. Chem. Soc., 103, 7352, 1981
Non-Patent Document 2: Aitkin C. T., Harrod J. F., Samuel E., J. Organomet. Chem., 1985, 279, C11
Non-Patent Document 3: Industrial Technology, 28 (8), 42, 1987
Non-Patent Document 4: Chemistry and Technology of Silicones, pp 387-409, Noll W., 1968, Academic Press

### SUMMARY OF INVENTION

The above-mentioned method of forming a pattern of conductive regions is weak in resistance to the stress between substrates. On the other hand, the replacement by silicone rubber base materials is difficult to accommodate the demand for feature size reduction and is not practically viable as the method for forming contacts in a stack of semiconductor chips.

An object of the invention is to provide a conductive pattern-forming composition capable of accommodating fine circuit formation as in a stack of semiconductor chips and for forming a microscopic conductive circuit pattern having stress resistance. Another object is to provide a method for forming a conductive circuit pattern.

The inventor has found that a microscopic conductive pattern having stress resistance can be formed by loading a silicone rubber composition, typically liquid, with a conductive filler consisting of submicron spherical silica particles having metallized surfaces or conductive submicron particles, typically metal submicron particles, applying the composition in a circuit pattern by a pattern printing technique, typically inkjet printing technique, and curing the composition into rubber.

In one aspect, the invention provides a conductive pattern-forming composition comprising

a silicone rubber composition comprising a curable organopolysiloxane and a curing agent, and

conductive fine particles having a maximum particle size of less than 1 μm.

In a preferred embodiment, the conductive fine particles are silica particles having metallized surfaces. In another preferred embodiment, the conductive fine particles are metal fine particles.

In another aspect, the invention provides a method for forming a conductive pattern, comprising coating the conductive pattern-forming composition defined above in a circuit pattern, and curing the composition into a rubber form.

The coating step is preferably by a printing technique, more preferably inkjet printing.

### ADVANTAGEOUS EFFECTS OF INVENTION

The conductive pattern-forming composition can be coated and delineated on a semiconductor substrate as a microscopic conductive pattern by a printing technique such as inkjet printing or stamping. The delineated circuit pattern is converted into rubber through crosslinking with the aid of a curing agent in the composition. The conductive circuit is endowed with stress resistance and reduced in size. Eventually a semiconductor circuit having reliability can be fabricated.

### DESCRIPTION OF EMBODIMENTS

The conductive pattern-forming composition of the invention, which is typically liquid, can be coated and patterned by a printing technique such as inkjet printing or stamping, to form a rubbery conductive circuit pattern. The conductive pattern-forming composition comprises a silicone rubber composition comprising a polysiloxane and a curing agent, and submicron conductive particles as essential components.

The conductive fine particles to be loaded in the conductive pattern-forming composition are of submicron size. Then a pattern of any desired shape can be formed by an inkjet printing or stamping technique.

Specifically the conductive particles of submicron size to be loaded have a maximum particle size of less than 1 μm and an average particle size of preferably 20 to 500 nm, and more preferably 30 to 300 nm. A powder (particles) with a relatively narrow particle size distribution is preferred. As used herein, the “average particle size” is obtained from measurements by the dynamic light scattering theory using laser light (FFT power spectroscopy), and the “maximum particle size” is determined from the particle size distribution obtained by plotting the measurement data.

The conductive fine particles are typically silica particles having metallized surfaces or metal fine particles.

The silica particles having metallized surfaces are obtained from particulate silica, preferably having an average particle size of 10 to 250 nm, more preferably 20 to 200 nm. Particulate silica may be metallized into conductive fine particles, for example, by the methods described in Patent Documents 2 and 3. Specifically, spherical silica having an average particle size of about 100 nm or less is commercially available, for example, as colloidal silica “Snowtex” series from Nissan Chemical Industries, Ltd. and X24-9163A from Shin-Etsu Chemical Co., Ltd. Spherical silica particles are surface treated with a silicon base polymer having a Si—Si or Si—H bond. The treated particles are immersed in a palladium chloride solution where colloidal palladium deposits on silica surfaces. This is followed by nickel plating and then gold plating.

More specifically, the metallization process includes the steps of:

(1) treating silica particles with a silicon compound, preferably a reductive silicon compound, to form a layer of the silicon compound on surfaces of silica particles,

(2) treating the particles of step (1) with a solution containing a salt of a metal having a standard oxidation reduction potential of at least 0.54 V, for depositing colloidal metal on the silicon compound layer around the silica surface,

(3) effecting electroless nickel plating on the silica particles, with the colloidal metal serving as a catalyst, for forming a metallic nickel layer on the surface of the silicon compound layer, and

(4) effecting gold plating for forming a gold layer on the nickel layer.

Step (1) uses the reductive silicon compound which is preferably selected from silicon base polymers having a Si—Si or Si—H bond, for example, polysilane, polysiloxane, and polysilazane having a Si—Si or Si—H bond.

The polysilane preferably has a structure of the formula (1):

(R¹R²Si)ₙ (1)

wherein R¹ and R² are each independently hydrogen or a substituted or unsubstituted monovalent hydrocarbon group, and n is such a number as to provide a molecular weight in the range described below.

Examples of the monovalent hydrocarbon group represented by R¹ and R² include straight or branched aliphatic hydrocarbon groups of 1 to 12 carbon atoms, preferably 1 to 6 carbon atoms, alicyclic hydrocarbon groups of 3 to 12 carbon atoms, preferably 5 to 12 carbon atoms, optionally having an alkyl substituent, and aromatic ring-containing hydrocarbon groups of 6 to 10 carbon atoms, optionally having an alkyl substituent on the aromatic ring. Preferred examples of the monovalent hydrocarbon group include alkyl groups such as methyl, ethyl, propyl, butyl, pentyl and hexyl, alicyclic groups such as cyclopentyl and cyclohexyl, and aromatic groups such as phenyl, tolyl, xylyl, naphthyl and benzyl.

Although the molecular weight is not particularly limited, the polysilane preferably has a weight average molecular weight of 800 to 1,000,000 as measured by gel permeation chromatography (GPC) versus polystyrene standards.

The polysilane may be synthesized by any well-known methods, for example, by the method of Non-Patent Document 1. It is noted that the polysilane disclosed in Non-Patent Document 2 is more preferable since it contains Si—H bonds as well as Si—Si bonds.

The polysiloxane may be a polysiloxane having a Si—H or Si—Si bond, represented by the formula (2):

(R³R⁴SiO)ₐ(R⁵HSiO)_{b}(R⁶R⁷Si)_{c} (2)

wherein R³, R⁴, R⁵, R⁶, and R⁷ are each independently a substituted or unsubstituted monovalent hydrocarbon group, alkoxy group or halogen atom, a, b and c are numbers meeting a+b+c=1, with the proviso that b and c are not 0 at the same time.

Examples of the monovalent hydrocarbon group represented by R³ to R⁷ include optionally substituted, straight, branched or cyclic aliphatic hydrocarbon groups of 1 to 12 carbon atoms, preferably 1 to 6 carbon atoms, and optionally substituted, aromatic ring-containing hydrocarbon groups of 6 to 14 carbon atoms, preferably 6 to 10 carbon atoms. Exemplary substituent groups include halogen atoms, hydroxyl, and alkoxy groups of 1 to 6 carbon atoms. Preferred examples of the monovalent hydrocarbon group include alkyl groups such as methyl, ethyl, propyl, butyl, pentyl and hexyl, cyclic alkyl groups such as cyclopentyl and cyclohexyl, and aromatic groups such as phenyl, tolyl, xylyl, naphthyl and benzyl.

Preferred examples of the alkoxy group represented by R³ to R⁷ include straight, branched or cyclic alkoxy groups of 1 to 6 carbon atoms, such as methoxy, ethoxy, propoxy, butoxy, pentyloxy, hexyloxy and cyclohexyloxy. Suitable halogen atoms represented by R³ to R⁷ include chlorine, bromine and iodine.

Although the molecular weight is not particularly limited, the polysiloxane preferably has a weight average molecular weight of 200 to 1,000,000 as measured by GPC versus polystyrene standards.

The polysiloxane having a Si—H or Si—Si bond may be synthesized by any well-known methods. In one common method, for example, polysiloxane is prepared by hydrolytic condensation of a hydrolyzable silane reactant while a hydrolyzable silane compound having a Si—Si bond is added as part or all of the hydrolyzable silane reactant.

The polysilazane may be a polymer represented by the formula (3):

(R⁸R⁹SiNR¹⁰)_{d}(R¹¹HSiNR¹²)ₑ(H₂SiNR¹³)_{f} (3)

wherein R⁸, R⁹, and R¹¹ are each independently a substituted or unsubstituted monovalent hydrocarbon group, alkoxy group or halogen atom, R¹⁰, R¹², and R¹³ are each independently a monovalent hydrocarbon group, d, e and f are numbers meeting d+e+f=1, with the proviso that e and f are not 0 at the same time.

Examples of the monovalent hydrocarbon group represented by R⁸ to R¹³ include optionally substituted, straight, branched or cyclic aliphatic hydrocarbon groups of 1 to 12 carbon atoms, preferably 1 to 6 carbon atoms, and optionally substituted, aromatic ring-containing hydrocarbon groups of 6 to 14 carbon atoms, preferably 6 to 10 carbon atoms. Exemplary substituent groups include halogen atoms, hydroxyl, and alkoxy groups of 1 to 6 carbon atoms. Preferred examples of the monovalent hydrocarbon group include alkyl groups such as methyl, ethyl, propyl, butyl, pentyl and hexyl, cyclic alkyl groups such as cyclopentyl and cyclohexyl, and aromatic groups such as phenyl, tolyl, xylyl, naphthyl and benzyl.

Preferred examples of the alkoxy group represented by R⁸, R⁹ and R¹¹ include straight, branched or cyclic alkoxy groups of 1 to 6 carbon atoms, such as methoxy, ethoxy, propoxy, butoxy, pentyloxy, hexyloxy and cyclohexyloxy. Suitable halogen atoms represented by R⁸, R⁹ and R¹¹ include chlorine, bromine and iodine.

Although the molecular weight is not particularly limited, the polysilazane preferably has a weight average molecular weight of 200 to 1,000,000 as measured by GPC versus polystyrene standards.

The polysilazane may be synthesized by any well-known methods, for example, by the method of Patent Document 4.

In the metallization process, step (1) of forming a silicon compound layer on surfaces of silica particles may be carried out by dissolving a silicon compound as defined above in an organic solvent, admitting silica particles into the solution, mixing, and removing the organic solvent. In this way, silica particles are covered on their surfaces with a layer of the silicon compound.

Examples of the organic solvent for dissolving the silicon compound in step (1) include aromatic hydrocarbon solvents such as benzene, toluene, and xylene; aliphatic hydrocarbon solvents such as hexane, octane and cyclohexane; ether solvents such as tetrahydrofuran and dibutyl ether; esters such as ethyl acetate; aprotic polar solvents such as dimethylformamide, dimethyl sulfoxide, and hexamethylphosphoric triamide; nitromethane and acetonitrile. The silicon compound solution may have a concentration of 0.01 to 50% by weight, preferably 0.01 to 30 wt %, and more preferably 1 to 20 wt %. A concentration of less than 0.01 wt % may correspond to a larger volume of solvent which adds to the cost, whereas a concentration in excess of 50 wt % may be difficult to cover the entire surfaces of particles with the silicon compound.

The treatment of particles with a silicon compound in an organic solvent may be carried out in various ways. First the particles are mixed with a dilution of the silicon compound in the solvent to form a slurry. This may be followed by the agitation mode of placing the slurry in a vessel with agitator blades, and rotating the agitator blades to effect dispersion and contact, or the spray mode of spraying the slurry into a gas stream for instantaneous drying.

At the last stage of treatment, the organic solvent is distilled off by elevating the temperature and/or reducing the pressure. Effective drying may be achieved while stirring at a temperature equal to or above the boiling point of the solvent, specifically a temperature of 40 to 200° C. under a vacuum of 1 to 100 mmHg.

At the end of treatment, the treated powder is held for some time in a dry atmosphere or at a temperature of 40 to 200° C. in vacuum until the solvent is fully evaporated off or the treated powder is fully dry. There is obtained silicon compound-treated powder.

The silicon compound layer preferably has a thickness of 1 to 10 nm, more preferably 1 to 5 nm. A layer of less than 1 nm may fail to completely cover a silica particle, leaving some areas unsusceptible to metal plating. A too thick layer may result in coated particles having too large a size or cause agglomeration.

The treatment with the silicon compound renders silica particles hydrophobic. Since the treated silica particles have a low affinity to the solvent in which the metal salt is dissolved, they are not dispersed in the solution. This may invite a drop in the efficiency of metal salt reduction reaction. Such a drop of efficiency of metal salt reduction reaction may be compensated for by adding a surfactant. Those surfactants capable of reducing surface tension without foaming are desirably used herein, for example, nonionic surfactants commercially available as Surfynol® 104, 420 and 504 from Nissin Chemical Industry Co., Ltd.

Step (2) is to treat the coated silica particles (silica particles surface coated with a silicon compound layer) of step (1) with a solution containing a salt of a metal having a standard oxidation reduction potential of at least 0.54 V, for depositing colloidal metal on the silicon compound layer around the silica surface. In this step, surfaces of the coated silica particles are brought in contact with a metal salt-containing solution. Due to the reducing action of the silicon compound, colloidal metal is deposited on the surface of the silicon compound layer to form a metal layer.

The salt of a metal having a standard oxidation reduction potential of at least 0.54 V is preferably a salt of gold (standard oxidation reduction potential 1.50 V), palladium (standard oxidation reduction potential 0.99 V), or silver (standard oxidation reduction potential 0.80 V). Note that salts of metals having a standard oxidation reduction potential of less than 0.54 V, such as copper (standard oxidation reduction potential 0.34 V) and nickel (standard oxidation reduction potential 0.25 V) are difficultly reduced by the silicon compound.

The gold salts are salts of Au⁺ or Au³⁺, for example, NaAuCl₄, NaAu(CN)₂, and NaAu(CN)₄. The palladium salts are salts of Pd²⁺, represented by the formula: Pd—Z₂ wherein Z is halogen such as Cl, Br or I, acetate, trifluoroacetate, acetylacetonate, carbonate, perchlorate, nitrate, sulfate or oxide. Examples include PdCl₂, PdBr₂, PdI₂, Pd(OCOCH₃)₂, Pd(OCOCF₃)₂, PdSO₄, Pd(NO₃)₂, and PdO. The silver salts are those which produce Ag⁺ when dissolved in a solvent, represented by the formula: Ag—Z wherein Z is perchlorate, borate, phosphate or sulfonate. Examples include AgBF₄, AgClO₄, AgPF₆, AgBPh₄, Ag(CF₃SO₃), and AgNO₃.

Examples of the solvent in which the metal salt is dissolved include water, ketones such as acetone and methyl ethyl ketone, alcohols such as methanol and ethanol, and aprotic polar solvents such as dimethylformamide, dimethyl sulfoxide and hexamethylphosphoric triamide. Inter alia, water is most preferred.

The concentration of the metal salt varies with a particular solvent in which the salt is dissolved although the preferred concentration is from 0.01% by weight to the saturation level. A concentration of less than 0.01 wt % may lead to a deposit having a less plating catalysis. Beyond the saturation level, the solid salt may precipitate out. When the solvent is water, the metal salt is preferably present in a concentration of 0.01 to 20% by weight, more preferably 0.1 to 5% by weight. The silicon compound-coated silica particles are immersed in the metal salt solution, preferably at room temperature to 70° C. for 0.1 to 120 minutes, more preferably 1 to 15 minutes. There are obtained colloidal metal-treated particles.

Preferably step (2) is carried out by first contacting the silicon compound-coated particles with a surfactant diluted with water, then contacting with a solution of the metal salt. This order of contacts prevents a possible drop in efficiency of metal salt reduction reaction that can occur because silica particles on their surfaces, which have been hydrophobized through step (1), i.e., silicon compound treatment, have so poor affinity to the solvent in which the metal salt is dissolved that they are difficultly dispersed in the solution. Namely, the silicon compound-coated particles can be readily and briefly dispersed in the metal salt solution.

The surfactants used herein encompass anionic, cationic, ampholytic and nonionic surfactants. The anionic surfactants include sulfonic acid salts, sulfuric ester salts, carboxylic salts, and phosphoric ester salts. The cationic surfactants include ammonium salts, alkylamine salts, and pyridinium salts. The ampholytic surfactants include betaine, aminocarboxylic acid, and amine oxide surfactants. The nonionic surfactants include ether, ester and silicone surfactants.

Exemplary anionic surfactants include alkylbenzenesulfonic acid salts, sulfosuccinic acid esters, polyoxyethylene sulfuric acid alkyl salts, alkylphosphoric acid esters, and long-chain fatty acid soaps. Exemplary cationic surfactants include alkyltrimethylammonium chlorides, dialkyldimethylammonium chlorides, and alkylpyridinium chlorides. Exemplary ampholytic surfactants include betaine sulfonic acid salts and betaine aminocarboxylic acid amine salts. Exemplary nonionic surfactants include polyoxyethylene alkyl ethers, polyoxyethylene fatty acid esters, and polyoxyalkylene-modified polysiloxanes. An aqueous solution of a mixture of such surfactants is also useful which is commercially available, for example, under the trade mark of Mama Lemon from Lion Corp.

When used, the surfactant may be added in an amount of 0.0001 to 10 parts, preferably 0.001 to 1 part, and more preferably 0.01 to 0.5 part by weight per 100 parts by weight of the metal salt solution.

After the metal salt treatment, the treated silica particles are treated with a similar solvent not containing the metal salt, whereby the unnecessary metal salt which is not attached to the particles is removed. Then the treated particles are dried by removing the unnecessary solvent. The drying is preferably effected at a temperature of 0 to 150° C. under atmospheric to subatmospheric pressure.

Step (3) is electroless nickel plating on the silica particles having colloidal metal deposited on their surfaces, with the colloidal metal serving as a catalyst, for forming a metallic nickel layer on the surface of the silicon compound layer.

The electroless nickel plating bath generally contains a water-soluble nickel salt such as nickel sulfate or nickel chloride, a reducing agent such as sodium hypophosphite, hydrazine or sodium boron hydride, a complexing agent such as sodium acetate, phenylenediamine, or potassium sodium tartrate, and the like. A commercially available bath may be used.

Electroless nickel plating may be carried out in a standard way, either by the batch mode of admitting the particles into an electroless nickel plating bath where plating takes place, or the dropwise mode of adding dropwise a plating solution to a dispersion of the particles in water. Reference may be made to Non-Patent Document 3. Although both the modes attempt to prevent agglomeration and to form a uniform deposit of tight adhesion by controlling the deposition rate, it is sometimes difficult to produce nickel-coated silica. For a powder having a high specific surface area, plating reaction is inherently very active, that is, plating reaction abruptly starts and soon becomes uncontrollable. On the other hand, the start of plating is often delayed by the influence of surrounding oxygen, taking a time for nickel plating. In either case, it is difficult to produce uniformly plated particles.

It has been found that the above-discussed problem can be avoided by carrying out nickel plating on silica in the following way. The nickel plating solution is divided into two, a nickel salt aqueous solution and an aqueous solution containing a reducing agent, pH adjuster, complexing agent and the like. The silica particles are dispersed in the reducing agent-containing aqueous solution, which is kept at an adequate temperature for nickel plating. The nickel salt aqueous solution is carried on a gas and fed into the reducing agent-containing aqueous solution having silica dispersed therein. This procedure is effective for forming nickel-coated silica particles without agglomeration. With the aid of carrier gas, the nickel salt aqueous solution is quickly and uniformly dispersed in the aqueous solution containing reducing agent, pH adjuster, complexing agent and the like whereby particles on their surfaces are plated with nickel.

Although the gas carrier feed can often invite a drop of plating efficiency due to foaming, this is prevented by adding an antifoaming surfactant. Preferred is an antifoaming surfactant capable of reducing surface tension. For example, polyether-modified silicone surfactant which is commercially available as KS-538 from Shin-Etsu Chemical Co., Ltd. is preferably used.

In the electroless nickel plating, the oxygen concentration of the plating solution has an impact on nickel deposition. If a high level of dissolved oxygen is present, nickel deposition is restrained because colloidal palladium serving as the nucleus of the plating catalyst is oxidized into palladium cations which dissolve in the solution, or the once deposited nickel surface is oxidized. On the other hand, if the level of dissolved oxygen is low, the plating solution becomes less stable, allowing nickel to deposit on any sites other than silica and resulting in formation of fine nickel grains or lumpy deposits. For this reason, the level of dissolved oxygen in the plating solution is preferably controlled to 1 to 20 ppm. A level in excess of 20 ppm may lead to a decline of deposition rate and development of non-plated spots. At a level lower than 1 ppm, lumpy deposits may be observed.

The gas carrier used herein is preferably a mixture of an oxygen-containing gas such as air and an inert gas such as argon or nitrogen. In the electroless deposition on a powder, although the start of deposition is often delayed, a phenomenon can occur that once deposition starts, the reaction runs away. To prevent such a phenomenon, the procedure of first feeding nitrogen as the carrier, confirming the start of nickel deposition reaction, then changing the carrier gas to air is effective. The deposition temperature is typically 35 to 120° C., and the contact time is typically 1 minute to 16 hours. More desirably deposition takes place at 40 to 85° C. for 10 to 60 minutes.

Subsequent to the electroless nickel plating, step (4) is to effect gold plating for forming a gold layer on the nickel layer.

The gold plating solution used herein may be either an electroplating bath or an electroless plating bath. Both the baths may be of well-known compositions, and commercially available baths may be used. The electroless gold plating bath is preferred. The electroless gold plating may be carried out in a standard way. It is effective that the oxidized or passivated surface of nickel is removed with dilute acid before gold plating. The deposition temperature and contact time are similar to those of nickel plating. The plating step may be followed by water washing to remove the unnecessary surfactant.

The thus obtained silica particles are metallized silica particles having a four-layer structure of silica/silicon compound/nickel/gold.

The nickel layer preferably has a thickness of 5 to 100 nm, more preferably 10 to 20 nm. A layer of less than 5 nm may fail to completely cover a silica particle and be insufficient in hardness and strength. A layer of more than 100 nm may correspond to a larger amount of nickel, which increases the cost of loading, and lead to increases in particle size and specific gravity, interfering with good dispersion.

The gold layer preferably has a thickness of 2 to 50 nm, more preferably 5 to 10 nm. A layer of less than 2 nm may have a high resistivity, failing to ensure conduction when loaded. A layer of more than 50 nm corresponds to a larger amount of gold, which increases the cost.

Finally, the metallized silica particles are desirably heat treated at a temperature of at least 200° C. in the presence of a reducing gas. The preferred treating conditions include a temperature of 200 to 900° C. and a time of 1 minute to 24 hours, more preferably 250 to 500° C. and 30 minutes to 4 hours. Through the heat treatment, the silicon compound between the silica core and the metal layer is converted into ceramic material which has higher heat resistance, insulation and adhesion. The heat treatment in a reducing atmosphere, typically hydrogen is effective for reducing the oxide in metals and converting the silicon compound to a stable structure. As a result, silica and metal are tenaciously bound in the metallized particles, which exhibit high conductivity.

It is understood that the heat treatment in hydrogen reducing atmosphere converts the silicon compound to a silicon carbide base ceramic material. That is, through the high-temperature treatment, the silicon compound between the silica core and the metal layer is, in part or in entirety, converted into ceramic material which has higher heat resistance, insulation and adhesion.

The conductive particles thus obtained desirably have a resistivity of up to 100 mΩ-cm (=100×10⁻³Ω-cm), more desirably up to 10 mΩ-cm, and even more desirably up to 5 mΩ-cm.

While the embodiment in which the conductive pattern-forming composition uses silica particles having a metal coating on their surfaces has been described, another embodiment may use metal fine particles as the additive for imparting conductivity. The metal fine particles used herein have a particle size of the order of 50 to 200 nm. Suitable metal particles include fine particles of gold, silver, copper, nickel, aluminum and the like, and cores of inexpensive metals such as nickel coated with gold plating. Those particles having at least a surface layer of non-corrodible metal or gold are more preferred. In the case of fine particles having a size of 100 nm or less on which uniform growth of a plating metal is difficult, metal fine particles are used as such because better results are sometimes obtained with respect to reliability. When metal fine particles are used instead of the metallized silica particles mentioned above, the particle size distribution is preferably narrow.

In the conductive pattern-forming composition, the conductive fine particles are preferably present in an amount of 300 to 2,000 parts, more preferably 600 to 1,500 parts, and even more preferably 800 to 1,200 parts by weight per 100 parts by weight of the curable organopolysiloxane to be described later. Outside the range, a smaller loading may fail to impart satisfactory conductivity whereas an excess loading may interfere with working.

The conductive pattern-forming composition is obtained by loading a silicone rubber composition with the conductive fine particles defined above, the silicone rubber composition comprising a curable organopolysiloxane and a curing agent. In the silicone rubber composition, a curable organopolysiloxane is used as a silicone rubber base for imparting stress resistance to the conductive circuit pattern into which the conductive pattern-forming composition is shaped. The curable organopolysiloxane is preferably an organopolysiloxane having an aliphatic unsaturated hydrocarbon group, typically alkenyl.

The organopolysiloxane undergoes crosslinkage between its molecules with the aid of the curing agent, converting to rubber. It is well known, for example, from Non-Patent Document 4 that silicone rubber is obtained from polysiloxane having an aliphatic unsaturated hydrocarbon group. Since the composition based on such an organopolysiloxane is liquid in the preparation stage, it can be coated onto a substrate in a circuit pattern by a standard printing technique such as inkjet printing or stamping, and then cured into rubber form so that the circuit pattern may be solidified while maintaining stress resistance.

Preferably the organopolysiloxane having an aliphatic unsaturated hydrocarbon group serving as the silicone rubber base has the average compositional formula (4):

R¹⁴ₙSiO_{(4-n)/2} (4)

wherein R¹⁴ is each independently a substituted or unsubstituted monovalent hydrocarbon group, at least two hydrocarbon groups having an aliphatic unsaturated bond being included per molecule, and n is a positive number from 1.98 to 2.02.

In formula (4), the monovalent hydrocarbon groups represented by R¹⁴ preferably include straight, branched or cyclic aliphatic hydrocarbon groups of 1 to 12 carbon atoms, more preferably 1 to 6 carbon atoms, and aromatic ring-containing groups of 6 to 14 carbon atoms, more preferably 6 to 10 carbon atoms, which may have one or more substituent radicals. Suitable substituent radicals include halogen atoms, hydroxyl, and alkoxy radicals of 1 to 6 carbon atoms.

Examples of the monovalent hydrocarbon group include alkyl groups such as methyl, ethyl, propyl, butyl, pentyl and hexyl, and cyclic alkyl groups such as cyclopentyl and cyclohexyl. Suitable aromatic ring-containing groups include aryl groups such as phenyl, tolyl, xylyl, and naphthyl, and aralkyl groups such as benzyl. Preferred examples of the hydrocarbon group having an aliphatic unsaturated bond include optionally substituted alkenyl and alkynyl groups of 2 to 14 carbon atoms, more preferably 2 to 10 carbon atoms, such as vinyl and allyl. In the polysiloxane, at least two hydrocarbon groups having aliphatic unsaturation are preferably included per molecule.

Although the molecular weight of the polysiloxane is not particularly limited, the polysiloxane should preferably have a weight average molecular weight (Mw) of 200 to 10,000 as measured by gel permeation chromatography (GPC) versus polystyrene standards.

The organopolysiloxane having an aliphatic unsaturated hydrocarbon group may be synthesized by any desired methods. One synthesis method is by mixing a hydrolyzable silane having an aliphatic unsaturated hydrocarbon group with a hydrolyzable silane free of an aliphatic unsaturated hydrocarbon group, followed by hydrolytic condensation. Alternatively, once a polysiloxane free of an aliphatic unsaturated hydrocarbon group is synthesized, a silane having an aliphatic unsaturated hydrocarbon group at either end is added thereto, and equilibration reaction is effected for end-capping. With respect to synthesis, reference should be made to Non-Patent Document 4.

The third essential component in the conductive pattern-forming composition is a curing agent. In the preferred embodiment wherein the composition is based on an organopolysiloxane having an aliphatic unsaturated hydrocarbon group, the curing agent functions as a catalyst to form crosslinks between polysiloxane molecules for curing into rubber form. The curing agent used herein may be either an organohydrogenpolysiloxane/platinum base catalyst system (i.e., curing agent for addition reaction) or an organic peroxide catalyst, both of which are well known in the art, for example, from Non-Patent Document 4.

Preferred examples of the platinum base catalyst include platinum element alone, platinum compounds, platinum complexes, chloroplatinic acid, and complexes of chloroplatinic acid with alcohol, aldehyde, ether and olefin compounds. The platinum base catalyst is desirably added in such an amount as to provide 1 to 2,000 ppm of platinum based on the weight of the organopolysiloxane having an aliphatic unsaturated hydrocarbon group.

The organohydrogenpolysiloxane is not particularly limited as long as it has at least two, preferably at least three silicon-bonded hydrogen atoms (SiH groups). It may be straight, branched or cyclic. Preferred is an organohydrogenpolysiloxane having the general formula (5):

R¹⁵_{f}H_{g}SiO_{(4-f-g)/2} (5)

wherein R¹⁵ is as defined for R⁸ in formula (3), f and g are numbers in the range: 0≦f<3, 0<g<3, and 0<f+g<3. It typically has a degree of polymerization of up to 300. Preferably R¹⁵ is free of aliphatic unsaturation.

Examples of the organohydrogenpolysiloxane include dimethylhydrogensilyl-terminated diorganopolysiloxane, copolymers of dimethylsiloxane units, methylhydrogensiloxane units and terminal trimethylsiloxy units, low viscosity fluids consisting of dimethylhydrogensiloxane [H(CH₃)₂SiO_{1/2}] units and SiO₂ units, 1,3,5,7-tetrahydrogen-1,3,5,7-tetramethylcyclotetrasiloxane, 1-propyl-3,5,7-trihydrogen-1,3,5,7-tetramethylcyclotetrasiloxane, and 1,5-dihydrogen-3,7-dihexyl-1,3,5,7-tetramethylcyclotetrasiloxane.

The organohydrogenpolysiloxane serving as the curing agent is desirably added in such an amount as to provide 50 to 500 mol % of silicon-bonded hydrogen (SiH group) based on the aliphatic unsaturated hydrocarbon group (typically alkenyl) in the polysiloxane.

Also the organic peroxide catalyst is effective for forming crosslinkage to the aliphatic unsaturated hydrocarbon group-containing polysiloxane. Examples include benzoyl peroxide, 2,4-dichlorobenzoyl peroxide, p-methylbenzoyl peroxide, o-methylbenzoyl peroxide, 2,4-dicumyl peroxide, 2,5-dimethyl-bis(2,5-t-butylperoxy)hexane, di-t-butyl peroxide, and t-butyl perbenzoate. The organic peroxide catalyst is desirably added in an amount of 0.1 to 5 parts by weight per 100 parts by weight of the polysiloxane having an aliphatic unsaturated hydrocarbon group.

Besides the essential components described above, the silicone rubber composition may further comprise a reinforcing silica powder as an optional component insofar as it does not impair the object of the invention. While the reinforcing silica powder is added for the purpose of obtaining a silicone rubber having good mechanical strength, it may have a specific surface area of at least 50 m²/g, preferably 100 to 300 m²/g. If the specific surface area is less than 50 m²/g, the cured composition may have insufficient mechanical strength. Examples of the reinforcing silica include fumed silica and precipitated silica. Silica may be surface treated with organosilicon compounds such as chlorosilane and hexamethyldisilazane for rendering the surface hydrophobic.

The reinforcing silica is desirably added in an amount of 3 to 70 parts, more desirably 10 to 50 parts by weight per 100 parts by weight of the polysiloxane having an aliphatic unsaturated hydrocarbon group. Less than 3 parts of silica may fail to achieve the desired reinforcing effect whereas more than 70 parts of silica may adversely affect workability and mechanical strength.

In combination with the conductive fine particles, another conductive agent selected from conductive carbon black, and conductive inorganic oxides such as conductive zinc white and conductive titania may be added to the composition. Also a filler such as silicone rubber powder, red iron oxide, ground quartz or calcium carbonate may be added as an extender.

Since the conductive pattern-forming composition is formulated as a liquid material containing conductive fine particles of submicron size, the composition can be readily coated onto a substrate and delineated in a circuit pattern of quality by any well-known printing techniques such as inkjet printing and stamping. The curable organopolysiloxane as the rubber base is then converted to rubber form through reaction with the curing agent whereby the thus delineated circuit pattern is completed as a conductive circuit. The temperature for forming crosslinks is in a range from the activating temperature of the curing agent to the decomposition temperature of the organic group on the side chain of the polysiloxane, specifically in a range of 50 to 200° C., and more specifically 70 to 180° C. By heating at such a temperature for 5 to 120 minutes, a rubbery conductive circuit is completed.

### EXAMPLE

Examples of the invention are given below by way of illustration and not by way of limitation.

### Synthesis Example 1

### (1) Preparation of Phenylpolysilane (PPHS)

In a flask purged with argon, a diethyl ether solution of methyl lithium was added to bis(cyclopentadienyl)dichlorozirconocene whereby bis(cyclopentadienyl)dimethylzirconocene was prepared in situ as a catalyst. To the catalyst, phenylsilane was added in an amount of 50 times the catalyst on a molar basis. With stirring, the contents were heated at 150° C. for 24 hours. The catalyst was then removed by adding a molecular sieve and filtration. There was obtained a substantially quantitative amount of PPHS in solid form, having a weight average molecular weight of 2,600.

### (2) Preparation of PPHS-Treated Spherical Silica

The powder used was spherical silica X24-9163A (Shin-Etsu Chemical Co., Ltd., average particle size 110 nm). In 180 g of toluene was dissolved 1 g of PPHS resulting from step (1). The silica powder, 100 g, was added to the solution, fully dispersed by an ultrasonic disperser, and stirred for 1 hour until a slurry was obtained. On a rotary evaporator, the slurry was heated at a temperature of 80° C. and a pressure of 45 mmHg until 65 g of toluene was distilled off. Further drying resulted in PPHS-treated spherical silica. It was finally disintegrated by a roller mill.

### (3) Preparation of Colloidal Palladium-Deposited Silica

Since the PPHS-treated spherical silica resulting from step (2) was rendered hydrophobic, it would float on water if admitted to water. The PPHS-treated spherical silica, 100 g, was admitted to 50 g of a 0.5 wt % aqueous solution of surfactant Surfynol 504 (Nissin Chemical Industry Ltd.). By operating an ultrasonic disperser, the silica could be dispersed within a short time of about 5 minutes. Palladium treatment was then carried out by adding 70 g of a 1 wt % PdCl₂ aqueous solution (0.7 g of palladium chloride or 0.4 g of palladium) to 150 g of the silica/water dispersion, agitating for 30 minutes, filtering and water washing. There was obtained colloidal palladium-deposited silica, that is, silica particles having colloidal palladium deposited on their surfaces and colored blackish grey. The silica particles were collected by filtration and washed with water, becoming ready for plating.

### (4) Nickel Plating of Colloidal Palladium-Deposited Silica

A reducing solution used for nickel plating was 100 g of a mixed solution of 2.0 M sodium hypophosphite, 1.0 M sodium acetate, and 0.5 M glycine diluted with deionized water. The colloidal palladium-deposited silica resulting from step (3) was dispersed in the reducing solution along with 0.5 g of antifoaming agent KS-538 (Shin-Etsu Chemical Co., Ltd.). With vigorous stirring, the solution was heated from room temperature to 65° C. To the solution, a dilution of 2.0 M sodium hydroxide in deionized water carried on air gas was added dropwise while a dilution of 1.0 M nickel sulfate in deionized water carried on nitrogen gas was added dropwise at the same time. With fine bubbling, silica particles turned black, indicating deposition of metallic nickel on their surfaces. Metallic nickel deposited on the entire surfaces of silica particles, with neither agglomerates nor lumpy deposits being observed.

### (5) Gold Plating of Nickel-Plated Silica

As the gold plating solution, 100 g of gold plating solution K-24N (Kojundo Chemical Laboratory Co., Ltd.) was used without dilution. The silica particles with metallic nickel deposited on their surfaces resulting from step (4) were dispersed in the gold plating solution. The silica particles were fully dispersed by an ultrasonic disperser. With vigorous stirring, the solution was heated from room temperature to 95° C. With fine bubbling, silica particles turned golden, indicating deposition of gold on their surfaces. The silica particles, which settled down on the bottom of the plating bath, were filtered, washed with water, and dried at 50° C. for 30 minutes. The particles were fired in a hydrogen-purged electric oven at 300° C. for 1 hour. A stereoscopic observation showed that the entire surface of each silica particle was covered with gold. On IPC analysis of silica particles, palladium, nickel and gold were detected.

### [Properties of Conductive Silica Particles of Silica/Silicon Base Polymer/Nickel/Gold Structure]

The resistivity of the gold-plated silica particles was determined by packing a 4-terminal cylindrical cell with the gold-plated silica particles, conducting a current flow of 1 to 10 mA between two terminals with an area of 0.2 cm² at opposite ends from a source measure unit SMU-257 (Keithley Instruments Inc.), and measuring a voltage drop between terminals spaced 0.2 cm apart at the center of the cylinder by means of model 2000 nanovolt meter (Keithley Instruments Inc.). The gold-plated silica particles resulting from step (5) had a resistivity of 2.2 mΩ-cm. The silica particles were milled in a mortar for 1 minutes and heat treated at 200° C. for 4 hours before they were examined for any change. The outer appearance and resistivity remained unchanged.

The particle size distribution of the gold-plated silica particles was measured by a laser scattering particle size distribution analyzer (Nanotrac UPA-EX by Nikkiso Co., Ltd.), finding an average particle size of 160 nm. No particles with a size in excess of 1 μm were contained.

### Comparative Synthesis Example 1

Silica particles were treated as in Synthesis Example 1 except that the starting powder was spherical silica US-10 (Mitsubishi Rayon Co., Ltd., average particle size 10 μm). The resulting large gold-plated silica particles had a resistivity of 2.0 mΩ-cm as measured by the nanovolt meter. After the silica particles were milled and heat treated, they remained unchanged. The particle size distribution of the gold-plated silica particles was measured, finding an average particle size of 11 μm.

### Experiments 1 to 8

Experiments 1 to 8 are to examine the basic formulation of conductive pattern-forming compositions and to determine the conductivity of the resulting patterns.

The metallized silica in Synthesis Example 1 (Experiments 1 to 3 and 6), gold nanosize powder (Aldrich, average particle size 50-130 nm) (Experiments 4 and 7), or silver nanosize powder (Aldrich, average particle size ≦100 nm) (Experiments 5 and 8) was added to silicone rubber compound KE-520-U (containing 85 wt % organopolysiloxane, Shin-Etsu Chemical Co., Ltd.) in a proportion shown in Table 1 to prepare a precursor conductive pattern-forming composition (prior to crosslinking agent being added). Peroxide C-8A (Shin-Etsu Chemical Co., Ltd.) was added to the precursor composition, which was pressure molded at 170° C. for 10 minutes into a sheet of 1 mm thick. The sheet was post-cured at 150° C. for 1 hour before its resistivity was measured according to the procedure of SRIS-2301. To examine environment dependency, the sheet was allowed to stand in an environment of 50° C. and 90% RH for 7 days, before a change of resistivity was examined. In Comparative Experiments, a less amount of the metallized silica, gold nanosize powder or silver nanosize powder was used. The results are also shown in Table 1.

TABLE 1

| Components | | Example | | | | | | | |
|---|---|---|---|---|---|---|---|---|---|
| (pbw) | | 1 | 2 | 3 | 4 | 5 | 6 | 7 | 8 |
| Precursor | KE-520-U | 100 | 100 | 100 | 100 | 100 | 100 | 100 | 100 |
| composition | Gold-plated | 800 | 1,000 | 1,200 | — | — | 200 | — | — |
| | silica | | | | | | | | |
| | Gold nanosize | — | — | — | 2,000 | — | — | 500 | — |
| | powder | | | | | | | | |
| | Silver nanosize | — | — | — | — | 1,000 | — | — | 300 |
| | powder | | | | | | | | |

| | | | | | | | | |
|---|---|---|---|---|---|---|---|---|
| Precursor composition | 100 | 100 | 100 | 100 | 100 | 100 | 100 | 100 |
| C-8A | 0.4 | 0.4 | 0.4 | 0.4 | 0.4 | 0.4 | 0.4 | 0.4 |
| Content of conductive | 50 | 56 | 60 | 51 | 49 | 20 | 21 | 22 |
| fine particles (vol %) | | | | | | | | |
| Initial resistivity | 2 × 10⁻² | 1 × 10⁻² | 6 × 10⁻³ | 4 × 10⁻³ | 3 × 10⁻³ | insulating | insulating | insulating |
| (Ω-cm) | | | | | | | | |
| Resistivity (Ω-cm) | 4 × 10⁻² | 2 × 10⁻² | 1 × 10⁻² | 8 × 10⁻³ | 5 × 10⁻³ | insulating | insulating | insulating |
| after 50° C./90% RH/7 days | | | | | | | | |

### Examples 1 to 3& Comparative Examples 1 to 3

Conductive pattern-forming compositions were newly prepared as the inkjet printing composition and compared with respect to patterned state and film state after crosslinking reaction. Comparison was made among silicone rubber base pattern-forming compositions (Examples 1 to 3, Comparative Examples 1, 2) and also with a polyamide-imide base composition (Comparative Example 3). Each composition was coated onto a substrate by the inkjet printing technique, and post cured at 100° C. for 1 hour, after which the pattern profile and the connection state were observed. The results are shown in Table 2.

TABLE 2

| Components | | Example | | | Comparative Example | | |
|---|---|---|---|---|---|---|---|
| (pbw) | | 1 | 2 | 3 | 1 | 2 | 3 |
| Pattern- | Polysiloxane/curing agent mix*¹ | 100 | 100 | 100 | 100 | 100 | — |
| forming | Polyamide-imide compound*² | — | — | — | — | — | 100 |
| composition | Gold-plated silica of | 800 | 1,000 | 1,200 | — | 800 | 1,000 |
| | Synthesis Example 1 | | | | | | |
| | Gold-plated silica of | — | — | — | 300 | 100 | — |
| | Comparative Synthesis Example 1 | | | | | | |

| | | | | | | |
|---|---|---|---|---|---|---|
| Coating by inkjet printing | ◯ | ◯ | ◯ | clogged | clogged | ◯ |
| Pattern profile | good | good | good | poor | poor | good |
| Conductive circuit connectivity*³ | ◯ | ◯ | ◯ | X | X | Δ |

| | |
|---|---|
| *¹Polysiloxane/curing agent mix | |
| vinyl-terminated polydimethylsiloxane | 57 pbw |
| platinum catalyst | 0.1 pbw |
| cyclotetramethyltetravinylsiloxane | 0.3 pbw |
| cyclotetramethylsiloxane | 4.1 pbw |

*²Polyamide-imide compound HPC6000 (Hitachi Chemical Co., Ltd.)
*³◯: good
X: could not be evaluated
Δ: some contact failures

It is seen from Table 2 that those compositions loaded with gold-plate silica particles with a large particle size (Comparative Examples 1 and 2) could not be effectively coated due to clogging during inkjet printing. Comparative Example 3 where the polyamide-imide resin composition was used instead of the silicone rubber composition sometimes failed in providing good conduction since some contacts formed by connection were poor.

Japanese Patent Application No. 2011-031004 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A conductive pattern-forming composition comprising
a silicone rubber composition comprising a curable organopolysiloxane and a curing agent, and
conductive fine particles having a maximum particle size of less than 1 μm.

2. The composition of claim 1 wherein the conductive fine particles are silica particles having metallized surfaces.

3. The composition of claim 1 wherein the conductive fine particles are metal fine particles.

4. A method for forming a conductive pattern, comprising coating the conductive pattern-forming composition of claim 1 in a circuit pattern, and curing the composition into a rubber form.

5. The method of claim 4 wherein the coating step is by a printing technique.

6. The method of claim 5 wherein the printing technique is inkjet printing.
